(19) United States
(12) Patent Application Publication
(10) Pub. No.: US 2015/0252305 A1
(43) Pub. Date: Sep. 10, 2015

(54) COMPOSITIONS COMPRISING A BITTERING AGENT

(71) Applicant: The Procter & Gamble Company, Cincinnati, OH (US)

(72) Inventors: Philip Frank SOUTER, Northumberland (GB); Regine LABEQUE, Neder Over Heembeek (BE)

(21) Appl. No.: 14/640,042

(22) Filed: Mar. 6, 2015

Related U.S. Application Data
(60) Provisional application No. 61/949,438, filed on Mar. 7, 2014.

(51) Int. Cl. C11D 3/32; C11D 17/04

(52) U.S. Cl. CPC C11D 3/32; C11D 17/043; C11D 17/045

(57) ABSTRACT

Compositions comprising a bittering agent. More specifically, unitized dose articles comprising a bittering agent. Methods of making unitized dose articles and/or films comprising a bittering agent.

### FIELD OF THE INVENTION

The invention relates to a water soluble unit dose comprising a liquid, a bittering agent, and a water-soluble film. The invention also relates to a process for making such soluble unit dose.

### BACKGROUND OF THE INVENTION

Detergents today are available in a wide variety of forms such as powders, granules, liquids, and gels. Unit dose detergent forms are becoming increasingly popular due to the convenience they offer the consumer on simplified dosing. Such forms are often highly concentrated which offers further sustainability advantages.

It is known in the art to use bittering substances to reduce the likelihood of accidental ingestion. For example, it is known to coat a unit dose article with Bitrex® (denatonium benzoate) to prevent accidental ingestion. It is also known to add bittering agents to such articles by incorporation of the bittering agents either in the film or by spraying, printing, or powdering onto the film.

Solely adding the bittering agent to the film is, however, a very inefficient means to add the bittering agent as there is inevitable waste associated with the manufacture of unit dose forms; the water-soluble film needs to be held on a roll, and the edges that are cut once the film is loaded with detergent are lost to scrap. There is also exchange over time between the film and the detergent it encases, meaning that the concentration of the bittering agent when added solely in the film drops over time. To compensate for this drop in activity, more bittering agent needs to be added to the film, and more is consequently lost to scrap.

The object of the present disclosure is, therefore, in some aspects, to provide an efficient means of delivering bittering agents in a sustainable and economic way to the surface of the film by adding bittering agents both to the detergent and to the film such that at all times from manufacture through the supply chain, there is a deterring level of bittering agent on the surface of the film.

### SUMMARY OF THE INVENTION

In some aspects, the present disclosure relates to a unit dose article comprising: water-soluble film, where the film comprises a first bittering agent; and a liquid composition encapsulated by the film, where the liquid composition comprises a second bittering agent.

In some aspects, the present disclosure relates to a method of making a unit dose article, comprising the steps of: providing a water-soluble film, where the film comprises a first bittering agent; providing a liquid composition, where the liquid composition comprises a second bittering agent; and encapsulating the liquid composition in the water-soluble film.

### DETAILED DESCRIPTION OF THE INVENTION

The present disclosure relates to unit dose articles that comprise a liquid and water-soluble film, where both the liquid and the film comprise a bittering agent. Solvents and actives in liquid-comprising unit dose articles tend to migrate into and through water-soluble film. Because both the liquid and film of the disclosed unit dose articles comprise a bittering agent, they equilibrate relatively quickly, thereby reducing the amount of net migration, particularly of the bittering agent. This allows the concentrations of bittering agent to stay relatively constant over time in the liquid and/or the film, for example, during the manufacturing process, during storage, during transport, at the point of purchase, and/or at the point of usage. This provides, for example, predictability to the manufacturer, vendor, and consumer, and allows for an efficient use of materials.

### DEFINITIONS

Features and benefits of the various embodiments of the present invention will become apparent from the following description, which includes examples of specific embodiments intended to give a broad representation of the invention. Various modifications will be apparent to those skilled in the art from this description and from practice of the invention. The scope is not intended to be limited to the particular forms disclosed and the invention covers all modifications, equivalents, and alternatives falling within the spirit and scope of the invention as defined by the claims.

As used herein, the articles including “the,” “a” and “an” when used in a claim or in the specification, are understood to mean one or more of what is claimed or described.

As used herein, the terms “include,” “includes” and “including” are meant to be non-limiting. The phases “comprising” or “comprises” are intended to include the more limiting phrases “consisting essentially of” and “consisting of.” Therefore, a composition that comprises a component may consist essentially of that component, or consist of that component.

As used herein, the terms “substantially free of” or “substantially free from” mean that the indicated material is at the very minimum not deliberately added to the composition to form part of it, or, preferably, is not present at analytically detectable levels. It is meant to include compositions whereby the indicated material is present only as an impurity in one of the other materials deliberately included.

As used herein, the term “soiled material” is used non-specifically and may refer to any type of flexible material consisting of a network of natural or artificial fibers, including natural, artificial, and synthetic fibers, such as, but not limited to, cotton, linen, wool, polyester, nylon, silk, acrylic, and the like, as well as various blends and combinations. Soiled material may further refer to any type of hard surface, including natural, artificial, or synthetic surfaces, such as, but not limited to, tile, granite, grout, glass, composite, vinyl, hardwood, metal, cooking surfaces, plastic, and the like, as well as blends and combinations.

In this description, all concentrations and ratios are on a weight basis of the composition unless otherwise specified.

### Form

In some aspects, the present invention is directed to a water soluble unit dose article. The unit dose article comprises water soluble film and a liquid composition encapsulated by the film. The liquid composition may be encapsulated in a compartment.

Typically, the unit dose article comprises at least one compartment, wherein the compartment comprises a composition. A unit dose article is intended to provide a single, easy to use dose of the composition contained within the article for a particular application.

The compartment should be understood as meaning a closed internal space within the unit dose article, which holds the composition. Preferably, the unit dose article comprises a water-soluble film. The unit dose article is manufactured such that the water-soluble film completely surrounds the composition and in doing so defines the compartment in which the composition resides. The unit dose article may comprise two films. A first film may be shaped to comprise an open compartment into which the composition is added. A second film is then laid over the first film in such an orientation as to close the opening of the compartment. The first and second films are then sealed together along a seal region. The seal region may comprise a flange. The flange is comprised of excess sealed film material that protrudes beyond the edge of the unit dose article and provides increased surface area for seal of the first and second films. The film is described in more detail below. In some aspects, the unit dose article comprises three films.

The unit dose article may comprise more than one compartment, even at least two compartments, or even at least three compartments. The compartments may be arranged in superposed orientation, i.e., one positioned on top of the other, where they may share a common wall. In one aspect, at least one compartment is superposed on another compartment. Alternatively, the compartments may be positioned in a side-by-side orientation, i.e., one orientated next to the other. The compartments may even be orientated in a ‘tire and rim’ arrangement, i.e., a first compartment is positioned next to a second compartment, but the first compartment at least partially surrounds the second compartment, but does not completely enclose the second compartment. Alternatively, one compartment may be completely enclosed within another compartment.

When the unit dose article comprises at least two compartments, one of the compartments may be smaller than the other compartment. When the unit dose article comprises at least three compartments, two of the compartments may be smaller than the third compartment, and preferably the smaller compartments are superposed on the larger compartment. The smaller superposed compartments preferably are orientated side-by-side.

When the unit dose article comprises at least two compartments, each compartment may comprise identical compositions, or each compartment may independently comprise a different composition. The compartments may be sensorially different; for example, the compartments may have different shapes, or they may be different colors.

The composition may be any suitable composition. The composition may be in the form of a solid, a liquid, a dispersion, a gel, a paste, or a mixture thereof. The compositions in each compartment of a multicompartment unit dose article may be different. However, typically at least one compartment of the unit dose article, preferably each compartment, comprises a liquid. The composition is described in more detail below.

### Bittering Agent

The unit dose article comprises a bittering agent. Typically, the water-soluble film comprises a bittering agent. Additionally, the liquid composition that is encapsulated by the film typically comprises a bittering agent.

The bittering agent is preferably a denatonium salt or a derivative thereof. In one aspect, the bittering agent is a denatonium salt selected from the group consisting of denatonium chloride, denatonium citrate, denatonium saccharide, denatonium carbonate, denatonium acetate, denatonium benzoate, and mixtures thereof. In one aspect, the liquid composition comprises a first denatonium salt and the film comprises a second denatonium salt that is different than the first denatonium salt.

A particularly preferred bittering agent is denatonium benzoate, also known as phenylmethyl-[2-[(2,6-dimethylphenyl)amino]-2-oxoethyl]-diethylammonium benzoate, CAS no. 3734-33-6. Denatonium benzoate is commercially sold as BITREX®, available from Macfarlan Smith, Edinburgh, Scotland, UK.

In some aspects, the bittering agent is a natural bitter substance. In some aspects, the bittering agent has a bitter value of from about 1000 to about 200000. In some aspects, the bittering agent is a natural bitter substance with a bitter value of from about 1000 to about 200000, where the natural bitter substance is selected from the group consisting of glycosides, isoprenoids, alkaloids, amino acids, and mixtures thereof. For example, suitable bittering agents also include Quercetin (3,3′,4′,5,7-pentahydroxyflavone); Naringin (4′,5,7-Trihydroxyflavanone-7-rhamnoglucoside); Aucubin; Amarogentin; Dihydrofoliamentin; Gentiopicroside; Gentiopicrin; Swertiamarin; Swerosid; Gentioflavosid; Centaurosid; Methiafolin; Harpagoside; Centapikrin; Sailicin; Kondurangin; Absinthin; Artabsin; Cnicin; Lactucin; Lactucopicrin; Salonitenolid; α-thujone; β-thujone; Desoxy Limonene; Limonin; Ichangin; iso-Obacunoic Acid; Obacunone; Obacunoic Acid; Nomilin; Ichangin; Nomilinoic acid; Marrubin; Prämarrubin; Carnosol; Carnosic acid; Quassin; Quinine hydrochloride; Quinine sulfate; Quinine dihydrochloride; Columbine; Caffeine; Threonine; Methionine; Phenylalanine; Tryptophan; Arginine; Histidine; Valine; Aspartic acid; Sucrose octaacetate; and mixtures thereof. Other suitable bittering agents include quinine bisulfate and hop extract (e.g., humulone).

The unit dose composition may comprise from about 0.00001% to about 1%, or about 0.0001% to about 0.5%, or about 0.001% to about 0.25%, or about from about 0.01% to about 0.1%, by weight of the unit dose composition, of bittering agent. In some aspects, the unit dose article comprises a bittering agent in a sufficient amount to provide a bitter taste.

Typically, the water-soluble film comprises a bittering agent, which may be a first bittering agent. Additionally, the liquid composition that is encapsulated by the film also comprises a bittering agent, which may be a second bittering agent. Preferably, the bittering agent present in the film and the bittering agent present in the liquid composition are the same bittering agent. Preferably, the bittering agent present in the film, the bittering agent in the liquid composition, or even more preferably both, comprises denatonium salts, preferably denatonium benzoate. Preferably, both the film and the liquid composition each comprise the bittering agents at the time of manufacture of the unit dose article. In other words, the film comprises a bittering agent before the film encapsulates the liquid composition.

In some aspects, the liquid comprises from about 50 to about 2500 ppm, or about 100 ppm to about 2000 ppm, or about 250 to about 1000 ppm, of said bittering agent. In some aspects, the film comprises from about 50 to about 1000 ppm, or from about 100 ppm to about 750 ppm, or from about 150 to about 500 ppm of said bittering agent. Putting a bittering agent, into the liquid may be more economical than putting the bittering agent directly into the film. Thus, it may be preferred that the parts per million of the bittering agent in the liquid composition is greater than the parts per million of the bittering agent in the film. However, so long as both components comprise the bittering agent, equilibrium via migration will be achieved more quickly than if one component were devoid of bittering agent.

In some aspects, the ratio of ppm of bittering agent in the liquid to the ppm of bittering agent in the film is from about 5:1 to about 1:2, or from about 3:1 to about 1:1, or about 1.5:1 to about 1:1.

It is recognized that the levels of bittering agent may change somewhat after the unit dose article is assembled due to migration. In some aspects, the film, the plasticizing agents of the film, and/or the plasticizing solvents of the liquid may be selected to induce or encourage rapid migration, so that equilibrium may be reached more quickly.

The bittering agent may be added to the film material prior to formation of the film, for example, prior to casting or extrusion of the film. In some aspects, the bittering agent is homogenously distributed throughout the film.

In some aspects, the bittering agent is applied to the film by dusting, coating, painting, printing, spraying, atomizing, or mixtures thereof, preferably spraying or atomizing, a composition comprising the bittering agent and a plasticizing solvent, which is described below. When the bittering agent is sprayed or atomized onto a film, the sprayed or atomized composition may be non-aqueous, meaning that it comprises less than 20%, or less than 15%, or less than 10%, or less than 5%, or less than 1% water by weight of the sprayed or atomized composition. The sprayed or atomized composition may even comprise zero percent water. Additionally, the sprayed or atomized composition may comprises from about 0.001% to about 40%, or from about 0.1% to about 35%, or from about 5% to about 30%, by weight of the sprayed or atomized composition, bittering agent.

In some aspects, the concentration of the bittering agent on the surface of the film is from about 10 ppb to about 10,000 ppm, or preferably from about 50 ppb to about 200 ppm, or more preferably from about 10 ppm to about 250 ppm. In some aspects, the concentration of the bittering agent is determined after storage of the unit dose article for one month at 25° C. and 60% relative humidity.

### Water-Soluble or Water-Dispersible Film

The film of the present invention is soluble or dispersible in water. The water-soluble film preferably has a thickness of from about 20 to about 150 microns, preferably about 35 to about 125 microns, even more preferably about 50 to about 110 microns, most preferably about 76 microns.

Preferably, the film has a water-solubility of at least 50%, preferably at least 75% or even at least 95%, as measured by the method set out here after using a glass-filter with a maximum pore size of 20 microns:

50 grams±0.1 gram of film material is added in a pre-weighed 400 ml beaker and 245 ml±1 ml of distilled water is added. This is stirred vigorously on a magnetic stirrer, labline model No. 1250 or equivalent and 5 cm magnetic stirrer, set at 600 rpm, for 30 minutes at 24° C. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the percentage solubility or dispersability can be calculated.

Preferred film materials are preferably polymeric materials. The film material can, for example, be obtained by casting, blow-moulding, extrusion, or blown extrusion of the polymeric material, as known in the art. Preferably the film is obtained by an extrusion process or by a casting process.

Preferred polymers (including copolymers, terpolymers, or derivatives thereof) suitable for use as film material are selected from polyvinyl alcohols (PVA), polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the polymers of the film material are free of carboxylate groups.

Preferably, the level of polymer in the film material, for example a PVA polymer, is at least 60%. The polymer can have any weight average molecular weight, preferably from about 1000 to 1,000,000, more preferably from about 10,000 to 300,000, yet more preferably from about 20,000 to 150,000.

Mixtures of polymers can also be used as the film material. This can be beneficial to control the mechanical and/or dissolution properties of the compartments or pouch, depending on the application thereof and the required needs. Suitable mixtures include for example mixtures wherein one polymer has a higher water-solubility than another polymer, and/or one polymer has a higher mechanical strength than another polymer. Also suitable are mixtures of polymers having different weight average molecular weights, for example a mixture of PVA or a copolymer thereof of a weight average molecular weight of about 10,000 to about 40,000, preferably about 20,000, and of PVA or copolymer thereof, with a weight average molecular weight of about 100,000 to about 300,000, preferably about 150,000. Also suitable herein are polymer blend compositions, for example comprising hydrolytically degradable and water-soluble polymer blends such as polylactide and polyvinyl alcohol, obtained by mixing polylactide and polyvinyl alcohol, typically comprising about 1-35% by weight polylactide and about 65% to 99% by weight polyvinyl alcohol. Preferred for use herein are polymers, preferably polyvinyl alcohol, which are from about 60% to about 99% hydrolysed, preferably from about 80% to about 99% hydrolysed, even more preferably from about 80% to about 90% hydrolysed, to improve the dissolution characteristics of the material.

Preferred films exhibit good dissolution in cold water, meaning unheated distilled water. Preferably such films exhibit good dissolution at temperatures 24° C., even more preferably at 10° C. By good dissolution it is meant that the film exhibits water-solubility of at least 50%, preferably at least 75% or even at least 95%, as measured, by the method set out here after using a glass-filter with a maximum pore size of 20 microns, described above. Water-solubility may be determined at 24° C., or preferably at 10° C.

Preferred films are those supplied by Monosol (Merrillville, Ind., USA) under the trade references M8630, M8900, M8779, and M8310 films described in U.S. Pat. No. 6,166,117 and U.S. Pat. No. 6,787,512, and PVA films of corresponding solubility and deformability characteristics. Other suitable films may include called Solublon® PT, Solublon® GA, Solublon® KC or Solublon® KL from the Aicello Chemical Europe GmbH, the films VF-HP by Kuraray or the films by Nippon Gohsei, such as Hi Selon. Further preferred films are those described in US2006/0213801, US2011/0188784, WO2010/119022, and U.S. Pat. No. 6,787,512. In some aspects, the film is selected so that the migration of the bittering agent from the liquid to the film occurs at a greater rate than the migration of the bittering agent to M8630 film under otherwise identical conditions. In some aspects, it is preferable to use a film that exhibits better dissolution than M8630 film, supplied by Monosol, at temperatures 24° C., even more preferably at 10° C. Migration and/or presence of the bittering agent on the film may be determined according to the methods given below.

Preferred water soluble films are those derived from a resin that comprises a blend of polymers, preferably wherein at least one polymer in the blend is polyvinyl alcohol. Preferably, the water soluble film resin comprises a blend of PVA polymers. For example, the PVA resin can include at least two PVA polymers, wherein as used herein the first PVA polymer has a viscosity less than the second PVA polymer. A first PVA polymer can have a viscosity of at least 8 centipoise (cP), 10 cP, 12 cP, or 13 cP and at most 40 cP, 20 cP, 15 cP, or 13 cP, for example in a range of about 8 cP to about 40 cP, or 10 cP to about 20 cP, or about 10 cP to about 15 cP, or about 12 cP to about 14 cP, or 13 cP. Furthermore, a second PVA polymer can have a viscosity of at least about 10 cP, 20 cP, or 22 cP and at most about 40 cP, 30 cP, 25 cP, or 24 cP, for example in a range of about 10 cP to about 40 cP, or 20 to about 30 cP, or about 20 to about 25 cP, or about 22 to about 24, or about 23 cP. The viscosity of a PVA polymer is determined by measuring a freshly made solution using a Brookfield LV type viscometer with UL adapter as described in British Standard EN ISO 15023-2:2006 Annex E Brookfield Test method. It is international practice to state the viscosity of 4% aqueous polyvinyl alcohol solutions at 20° C. All viscosities specified herein in cP should be understood to refer to the viscosity of 4% aqueous polyvinyl alcohol solution at 20° C., unless specified otherwise. Similarly, when a resin is described as having (or not having) a particular viscosity, unless specified otherwise, it is intended that the specified viscosity is the average viscosity for the resin, which inherently has a corresponding molecular weight distribution.

The individual PVA polymers can have any suitable degree of hydrolysis, as long as the degree of hydrolysis of the PVA resin is within the ranges described herein. Optionally, the PVA resin can, in addition or in the alternative, include a first PVA polymer that has a Mw in a range of about 50,000 to about 300,000 Daltons, or about 60,000 to about 150,000 Daltons; and a second PVA polymer that has a Mw in a range of about 60,000 to about 300,000 Daltons, or about 80,000 to about 250,000 Daltons.

Different film material and/or films of different thickness may be employed in making the compartments of the present invention. A benefit in selecting different films is that the resulting compartments may exhibit different solubility or release characteristics.

The film material herein can also comprise one or more additive ingredients. For example, the film preferably comprises a plasticizing agent. The plasticizing agent may comprise water, glycerol, ethylene glycol, diethylene glycol, propylene glycol, sorbitol, or mixtures thereof. In some aspects, the film comprises from about 2% to about 35%, or from about 5% to about 25%, by weight of the film, a plasticizing agent selected from group comprising water, glycerol, diethylene glycol, sorbitol, and mixtures thereof. In some aspects, the film material comprises at least two, or preferably at least three, plasticizing agents. In some aspects, the film is substantially free of ethanol, meaning that the film comprises from 0% (including 0%) to about 0.1% ethanol by weight of the film. In some aspects, the plasticizing agents are the same as the plasticizing solvents in the liquid composition, described below.

Other additives may include water and functional detergent additives, including surfactant, to be delivered to the wash water, for example, organic polymeric dispersants, etc.

### Liquid Composition

The unit dose articles of the present composition comprise a liquid composition. The liquid composition may be encapsulated by the water-soluble film. The liquid composition comprises a bittering agent. Where the unit dose comprises multiple liquid compartments, the bittering agent may be added to or present in one, two, or even all the compartments.

### Plasticizing Solvent

In some aspects, the liquid composition further comprises a plasticizing solvent. The liquid composition may comprise from about 10% to about 50%, or from about 15% to about 40%, by weight of the liquid composition, of the plasticizing solvent.

When the liquid composition comprises both a bittering agent and a plasticizing solvent, the plasticizing solvent is preferably selected to induce the bittering agent to migrate from the liquid composition to the water-soluble film in order to facilitate rapid equibrilation. The liquid composition may consist essentially of the bittering agent and the plasticizing solvent, or the liquid composition may comprise other adjuncts, which are described in more detail below.

The plasticizing solvent in the present compositions may be a plasticizing solvent containing water, organic solvent, or mixtures thereof. Suitable organic solvents include low molecular weight alcohols and/or low molecular weight glycols, wherein “low molecular weight” in this context means having a molecular weight of less than about 500. Suitable organic solvents preferably include glycerol, 1,2-propanediol, 1,3-propanediol, dipropylene glycol, diethylene glycol, sorbitol, and mixtures thereof. In some aspects, the plasticizing solvent comprises water, glycerol, 1,2-propanediol, 1-3-propanediol, dipropylene glycol, diethylene glycol, sorbitol, or mixtures thereof.

In some aspects, the plasticizing solvent comprises at least one primary solvent, preferably an organic solvent, having Hansen solubility (δ) of greater than 29, more preferably greater than 30, and preferably less than 40. For reference, the Hansen solubility for water is approximate 42.

Without wishing to be bound by theory, it is believed that solvents with relatively higher Hansen solubility values tend to migrate through water soluble film at greater rates and levels than solvents with relatively lower Hansen solubility values. Such solvents, then, induce migration of components from the liquid into and through the film. As a unit dose manufacturer generally seeks to minimize migration through film, it is thus counter-intuitive to select a solvent with relatively high Hansen solubility, for example, greater than 29.

The Hansen solubility parameter is a well known and calculated parameter based on a three component measuring system. The Hansen solubility parameter is based on a dispersion force component (δ_{d}), a hydrogen bonding component (δₕ), and a polar component (δₚ). The Hansen solubility parameter (δ) is derived from the fact that the total cohesive energy, which is the energy required to break all the cohesive bonds, is the combination of the dispersion forces (d), the molecular dipole forces (p) and the hydrogen bonding forces (h) according to the following equation:

δ²=δ_{d}²+δₚ²+δₕ²

The Hansen solubility (δ) is calculated by finding the square root of δ².

Dispersion forces are weak attractive forces between non-polar molecules. The magnitude of these forces depends on the polarizability of the molecule, and the dispersion force component (δ_{d}) typically increases with increasing volume (and size) of the molecule, all other properties being roughly equal. Hansen solubility parameters are calculated at 25° C., with ChemSW's molecular modeling Pro v6.1.9 software package which uses an unpublished proprietary algorithm that is based on values published in the Handbook of solubility Parameters and other parameters by Allan F M Barton (CRC Press 1983) for solvents obtained experimentally by Hansen.

The primary solvent preferably has a cLog P of less than −1.0 and more preferably less than −1.5. The primary solvent preferably has a Hydrogen bonding component (δₕ) of greater than 20.5, more preferably greater than 23, and preferably less than 40. For reference, the Hansen solubility for water is approximately 42. The units used are MPa^{0.5}.

The primary solvent is preferably selected from the group consisting of propanediol, glycerol, sorbitol, and mixtures thereof.

Table 1 shows the Hansen Solubility components of the preferred primary solvents and some comparative solvents falling outside of the scope of the preferred primary solvents.

TABLE 1
Hansen solubility component parameters

| | δ Dis- | δ Po- | δ H- | | cLog |
|---|---|---|---|---|---|
| Solvent | persion | larity | bonding | δ | P |
| PEG 200 | 16.54 | 11.22 | 20.91 | 28.9 | −1.47 |
| PEG 300 | 16.23 | 10.09 | 20.17 | 27.8 | −1.22 |
| PEG 400 | 15.81 | 8.21 | 19.12 | 26.1 | −0.7 |
| PEG 600 | 18.98 | 11.22 | 20.91 | 28.9 | −0.74 |
| DPG | 16.67 | 10.86 | 20.35 | 28.5 | −0.6 |
| Propane diol | 16.41 | 10.82 | 23.07 | 30.3 | −1.1 |
| Glycerol | 17.29 | 12.22 | 27.34 | 34.6 | −1.94 |
| Sorbitol | 19.24 | 11.5 | 23.4 | 32.4 | −2.54 |
| nBPP | 15.99 | 5.42 | 8.91 | 19.1 | +1.99 |

In a preferred embodiment, the plasticizing solvent also comprises a secondary solvent, which is preferably an organic solvent. The secondary solvent preferably has Hansen solubility of 28.5 or less. In a further preferred embodiment the ratio of primary solvent to secondary solvent is from 7:1 to 1:5, more preferably from 6.5:1 to 1:3, most preferably 3:1 to 1:1.

In a particularly preferred embodiment, the plasticizing solvent comprises at least a primary solvent, a secondary solvent, and water.

In some aspects, the plasticizing solvent comprises at least two, or preferably at least three organic solvents. In some aspects, the liquid composition is substantially free of ethanol, meaning that the liquid composition comprises from 0% (including 0%) to about 0.1% ethanol by weight of the liquid composition.

The liquid composition may comprise water. However, because the liquid composition will be in contact with water-soluble film, it is typically desirable to limit the amount of water so as to preserve the film's integrity and to prevent a tacky feel to the pouches. Therefore, in some embodiments, the liquid composition comprises less than about 40% water by weight of the liquid composition, or from about 1% to about 30%, or preferably from about 2% to about 20%, or from about 5% to about 13%, water by weight of the liquid composition.

In some aspects, at least two of the organic solvents of the plasticizing solvent are the same as at least two of the plasticizing agents of the film material. In some aspects, the plasticizing solvent is selected to induce said bittering agent to migrate from said liquid composition to said water-soluble film so that equilibrium may be achieved more rapidly. In order to induce migration, the concentration of plasticizing solvent in the liquid composition and the concentration of plasticizing agents in the film are typically different, preferably different at the time of manufacture.

Plasticizing solvent may be present in any or all compartments of a multi-compartment unit dose article. Plasticizing solvent may be present in a compartment that is free of bittering agent.

### Adjuncts

The unit dose compositions described herein may comprise other adjuncts. Adjuncts may be selected according to the unit dose composition's intended function. The adjuncts may be contained in the same compartment as the liquid composition, which may be a first composition. Put another way, the liquid composition preferably comprises other adjuncts. In some aspects, in the case of multi-compartment unit dose articles, the adjuncts may be part of a non-first (e.g., second, third, fourth, etc.) composition encapsulated in compartments separate from the liquid composition. The non-first composition may be any suitable composition. The non-first composition may be in the form of a solid, a liquid, a dispersion, a gel, a paste or a mixture thereof.

Similarly, the adjuncts may be encapsulated in the same compartment as the bittering agent, or the adjuncts, or at least some adjuncts, may be separated from the bittering agent.

It is understood that the adjuncts and compositions listed below may be comprised in any compartment of the unit dose composition, including the liquid composition, the second composition (if present), or any other composition that may be present.

Non-limiting examples of unit dose compositions include cleaning compositions, fabric care compositions and hard surface cleaners. More particularly, the compositions may be a laundry, fabric care or dish washing composition including, pre-treatment or soaking compositions and other rinse additive compositions. The composition may be a fabric detergent composition or an automatic dish washing composition. The fabric detergent composition may be used during the main wash process or could be used as pre-treatment or soaking compositions.

Fabric care compositions include fabric detergents, fabric softeners, 2-in-1 detergent and softening, pre-treatment compositions and the like. Fabric care compositions may comprise typical fabric care adjuncts, including surfactants, builders, chelating agents, dye transfer inhibiting agents, dispersants, enzymes, and enzyme stabilizers, catalytic materials, bleach activators, polymeric dispersing agents, clay soil removal/anti-redeposition agents, brighteners, suds suppressors, dyes, additional perfume and perfume delivery systems, structure elasticizing agents, fabric softeners, carriers, hydrotropes, processing aids and/or pigments and mixtures thereof. The composition may be a laundry detergent composition comprising an adjunct selected from the group comprising a shading dye, surfactant, polymers, perfumes, encapsulated perfume materials, structurant and mixtures thereof.

The composition may be an automatic dish washing composition comprising an adjunct selected from surfactant, builder, sulfonated/carboxylated polymer, silicone suds suppressor, silicate, metal and/or glass care agent, enzyme, bleach, bleach activator, bleach catalyst, source of alkalinity, perfume, dye, solvent, filler and mixtures thereof.

Preferably, the liquid composition comprises a surfactant. Surfactants can be selected from anionic, cationic, zwitterionic, non-ionic, amphoteric or mixtures thereof. Preferably, the unit dose composition comprises anionic surfactant, non-ionic surfactant, or mixtures thereof.

The anionic surfactant may be selected from linear alkyl benzene sulfonate, alkyl ethoxylate sulphate and combinations thereof.

Suitable anionic surfactants useful herein can comprise any of the conventional anionic surfactant types typically used in liquid detergent products. These include the alkyl benzene sulfonic acids and their salts as well as alkoxylated or non-alkoxylated alkyl sulfate materials.

Suitable nonionic surfactants for use herein include the alcohol alkoxylate nonionic surfactants. Alcohol alkoxylates are materials which correspond to the general formula: R¹(CₘH₂ₘO)ₙOH wherein R¹ is a C₈-C₁₆ alkyl group, m is from 2 to 4, and n ranges from about 2 to 12. In one aspect, R¹ is an alkyl group, which may be primary or secondary, that comprises from about 9 to 15 carbon atoms, or from about 10 to 14 carbon atoms. In one aspect, the alkoxylated fatty alcohols will also be ethoxylated materials that contain from about 2 to 12 ethylene oxide moieties per molecule, or from about 3 to 10 ethylene oxide moieties per molecule.

The shading dyes employed in the present laundry care compositions may comprise polymeric or non-polymeric dyes, pigments, or mixtures thereof. Preferably the shading dye comprises a polymeric dye, comprising a chromophore constituent and a polymeric constituent. The chromophore constituent is characterized in that it absorbs light in the wavelength range of blue, red, violet, purple, or combinations thereof upon exposure to light. In one aspect, the chromophore constituent exhibits an absorbance spectrum maximum from about 520 nanometers to about 640 nanometers in water and/or methanol, and in another aspect, from about 560 nanometers to about 610 nanometers in water and/or methanol.

Although any suitable chromophore may be used, the dye chromophore is preferably selected from benzodifuranes, methine, triphenylmethanes, napthalimides, pyrazole, napthoquinone, anthraquinone, azo, oxazine, azine, xanthene, triphenodioxazine and phthalocyanine dye chromophores. Mono and di-azo dye chromophores are preferred.

The shading dye may comprise a dye polymer comprising a chromophore covalently bound to one or more of at least three consecutive repeat units. It should be understood that the repeat units themselves do not need to comprise a chromophore. The dye polymer may comprise at least 5, or at least 10, or even at least 20 consecutive repeat units.

The repeat unit can be derived from an organic ester such as phenyl dicarboxylate in combination with an oxyalkyleneoxy and a polyoxyalkyleneoxy. Repeat units can be derived from alkenes, epoxides, aziridine, carbohydrate including the units that comprise modified celluloses such as hydroxyalkylcellulose; hydroxypropyl cellulose; hydroxypropyl methylcellulose; hydroxybutyl cellulose; and, hydroxybutyl methylcellulose or mixtures thereof. The repeat units may be derived from alkenes, or epoxides or mixtures thereof. The repeat units may be C2-C4 alkyleneoxy groups, sometimes called alkoxy groups, preferably derived from C2-C4 alkylene oxide. The repeat units may be C2-C4 alkoxy groups, preferably ethoxy groups.

For the purposes of the present disclosure, the at least three consecutive repeat units form a polymeric constituent. The polymeric constituent may be covalently bound to the chromophore group, directly or indirectly via a linking group. Examples of suitable polymeric constituents include polyoxyalkylene chains having multiple repeating units. In one aspect, the polymeric constituents include polyoxyalkylene chains having from 2 to about 30 repeating units, from 2 to about 20 repeating units, from 2 to about 10 repeating units or even from about 3 or 4 to about 6 repeating units. Non-limiting examples of polyoxyalkylene chains include ethylene oxide, propylene oxide, glycidol oxide, butylene oxide and mixtures thereof.

The dye may be introduced into the detergent composition in the form of the unpurified mixture that is the direct result of an organic synthesis route. In addition to the dye polymer therefore, there may also be present minor amounts of un-reacted starting materials, products of side reactions and mixtures of the dye polymers comprising different chain lengths of the repeating units, as would be expected to result from any polymerisation step.

The compositions can comprise one or more detergent enzymes which provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. A typical combination is a cocktail of conventional applicable enzymes like protease, lipase, cutinase and/or cellulase in conjunction with amylase.

The compositions of the present invention may comprise one or more bleaching agents. Suitable bleaching agents other than bleaching catalysts include photobleaches, bleach activators, hydrogen peroxide, sources of hydrogen peroxide, pre-formed peracids and mixtures thereof. In general, when a bleaching agent is used, the compositions of the present invention may comprise from about 0.1% to about 50% or even from about 0.1% to about 25% bleaching agent by weight of the cleaning composition.

The composition may comprise a brightener. Suitable brighteners are stilbenes, such as brightener 15. Other suitable brighteners are hydrophobic brighteners, and brightener 49. The brightener may be in micronized particulate form, having a weight average particle size in the range of from 3 to 30 micrometers, or from 3 micrometers to 20 micrometers, or from 3 to 10 micrometers. The brightener can be alpha or beta crystalline form.

The compositions herein may also optionally contain one or more copper, iron and/or manganese chelating agents. If utilized, chelating agents will generally comprise from about 0.1% by weight of the compositions herein to about 15%, or even from about 3.0% to about 15% by weight of the compositions herein. Suitable chelants include a chelant selected from the group consisting of DTPA (Diethylene triamine pentaacetic acid), HEDP (Hydroxyethane diphosphonic acid), DTPMP (Diethylene triamine penta(methylene phosphonic acid)), ethylenediaminedisuccinic acid (EDDS), 1,2-Dihydroxybenzene-3,5-disulfonic acid disodium salt hydrate, and derivatives of such chelants.

The composition may comprise a calcium carbonate crystal growth inhibitor, such as one selected from the group consisting of: 1-hydroxyethanediphosphonic acid (HEDP) and salts thereof; N,N-dicarboxymethyl-2-aminopentane-1,5-dioic acid and salts thereof; 2-phosphonobutane-1,2,4-tricarboxylic acid and salts thereof; and any combination thereof.

The compositions of the present disclosure may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in the compositions herein, the dye transfer inhibiting agents are present at levels from about 0.0001%, from about 0.01%, from about 0.05% by weight of the cleaning compositions to about 10%, about 2%, or even about 1% by weight of the cleaning compositions.

The composition may comprise one or more polymers. Suitable polymers include carboxylate polymers, polyethylene glycol polymers, polyester soil release polymers such as terephthalate polymers, amine polymers, cellulosic polymers, dye transfer inhibition polymers, dye lock polymers such as a condensation oligomer produced by condensation of imidazole and epichlorhydrin, optionally in ratio of 1:4:1, hexamethylenediamine derivative polymers, and any combination thereof.

Other suitable cellulosic polymers may have a degree of substitution (DS) of from 0.01 to 0.99 and a degree of blockiness (DB) such that either DS+DB is of at least 1.00 or DB+2DS−DS² is at least 1.20. The substituted cellulosic polymer can have a degree of substitution (DS) of at least 0.55. The substituted cellulosic polymer can have a degree of blockiness (DB) of at least 0.35. The substituted cellulosic polymer can have a DS+DB, of from 1.05 to 2.00. A suitable substituted cellulosic polymer is carboxymethylcellulose.

Another suitable cellulosic polymer is cationically modified hydroxyethyl cellulose.

Suitable perfumes include perfume microcapsules, polymer assisted perfume delivery systems including Schiff base perfume/polymer complexes, starch-encapsulated perfume accords, perfume-loaded zeolites, blooming perfume accords, and any combination thereof. A suitable perfume microcapsule is melamine formaldehyde based, typically comprising perfume that is encapsulated by a shell comprising melamine formaldehyde. It may be highly suitable for such perfume microcapsules to comprise cationic and/or cationic precursor material in the shell, such as polyvinyl formamide (PVF) and/or cationically modified hydroxyethyl cellulose (catHEC). Suitable suds suppressors include silicone and/or fatty acid such as stearic acid.

### Process for Machine Washing

The present disclosure also relates to a process for the machine washing of laundry or dishware using an article according to the present disclosure, comprising the steps of, placing at least one article according to the present invention into the washing machine along with the laundry or dishware to be washed, and carrying out a washing or cleaning operation.

Any suitable washing machine may be used. Those skilled in the art will recognize suitable machines for the relevant wash operation. The article of the present invention may be used in combination with other compositions, such as fabric additives, fabric softeners, rinse aids, and the like.

Additionally, the unit dose articles of the present disclosure may be used in known hand washing methods.

### Process for Making

The present invention is also to a method of making the unit dose article. In some aspects, the present disclosure relates to a method of making a unit dose article, comprising the steps of: providing a liquid composition, where the liquid composition comprises a bittering agent; providing a water-soluble film, where the film also comprises a bittering agent; and encapsulating the liquid composition in the water-soluble film.

In some aspects of the method, the bittering agent present in the film, the bittering agent present in the liquid composition, or both comprise a member selected from the group consisting of: denatonium salts or a derivative thereof; Quercetin (3,3′,4′,5,7-pentahydroxyflavone); Naringin (4′,5,7-Trihydroxyflavanone-7-rhamnoglucoside); Aucubin; Amarogentin; Dihydrofoliamentin; Gentiopicroside; Gentiopicrin; Swertiamarin; Swerosid; Gentioflavosid; Centaurosid; Methiafolin; Harpagoside; Centapikrin; Sailicin; Kondurangin; Absinthin; Artabsin; Cnicin; Lactucin; Lactucopicrin; Salonitenolid; α-thujone; β-thujone; Desoxy Limonene; Limonin; Ichangin; iso-Obacunoic Acid; Obacunone; Obacunoic Acid; Nomilin; Ichangin; Nomilinoic acid; Marrubin; Prämarrubin; Camosol; Carnosic acid; Quassin; Quinine hydrochloride; Quinine sulfate; Quinine dihydrochloride; Columbine; Caffeine; Threonine; Methionine; Phenylalanine; Tryptophan; Arginine; Histidine; Valine; Aspartic acid; Sucrose octaacetate; Qunine bisulfate; hop extract; and mixtures thereof. In some aspects, either or both bittering agents in the film and/or liquid is a denatonium salt or derivative thereof, preferably denatonium benzoate. In some aspects, the bittering agent present in the film and the bittering agent present in the liquid composition are the same bittering agent.

In some aspects of the method, the liquid, preferably at the time of manufacture of the unit dose article, comprises from about 50 to about 2500 ppm of the bittering agent. In some aspects of the method, the film, preferably at the time of manufacture of the unit dose article, comprises from about 50 to about 1000 ppm of said bittering agent. In some aspects of the method, the ratio of ppm of bittering agent in the liquid to the ppm of bittering agent in the film is from about 5:1 to about 1:2, or from about 3:1 to about 1:1, or about 1.5:1 to about 1:1.

In some aspects of the method, the liquid composition further comprises a plasticizing solvent comprising water, glycerol, diethylene glycol, dipropylene glycol, sorbitol, or mixtures thereof. The liquid composition may comprise from about 2% to about 20%, by weight of said liquid composition, of water. In some aspects, the further comprises from about 2% to about 35%, by weight of the film, of a plasticizing agent selected from the group consisting of water, glycerol, diethylene glycol, sorbitol, and mixtures thereof.

In some aspects, the unit dose article comprises preferably two or more, or three, or four, or five, compartments.

In some aspects, the bittering agent is applied to the film by dusting, coating, painting, printing, spraying, atomizing, or mixtures thereof, preferably spraying or atomizing, the bittering agent, preferably with a solvent, onto said film. The film may be formed into a pouch after the spraying or atomizing. In some aspects, the bittering agent is added to the film material prior to formation of the film, for example, prior to casting or extrusion of the film. In some aspects, the bittering agent is homogenously distributed throughout the film.

When a liquid composition is contacted with a film, for example through spraying or atomizing, the integrity of the film may become compromised. Without wishing to be bound by theory, it is believed that the water-soluble film may partially dissolve upon such contact, particularly when the liquid composition comprises water. Therefore, the liquid composition may further comprise a repairing agent that helps to restore the integrity of the film. In some aspects, a liquid composition comprising a repairing agent is sprayed or atomized onto the film. In some aspects, the repairing agent comprises a polymer, preferably a polymer found in the film. In some aspects, the liquid composition comprises polyvinyl alcohol, which may be particularly preferred when the liquid composition is sprayed or atomized onto film that comprises polyvinyl alcohol. Without wishing to be bound by theory, it is believed that the repairing agent, e.g., the polymer, in the liquid composition helps to repair, replace, or reinforce components, e.g., film polymers, that may have been lost or weakened due to dissolution during the contacting step.

The method of making the unit dose compositions is described in more detail below.

The process of the present disclosure may be continuous or intermittent. The process comprises the general steps of forming an open pouch, preferably by forming a water-soluble film into a mould to form said open pouch, filling the open pouch with a composition, preferably the liquid composition, closing the open pouch filled with a composition, preferably using a second water-soluble film to form the unit dose article. The second film may also comprise compartments, which may or may not comprise compositions. Alternatively, the second film may be a second closed pouch containing one or more compartments, used to close the open pouch. Preferably, the process is one in which a web of unit dose article are made, said web is then cut to form individual unit dose articles.

Alternatively, the first film may be formed into an open pouch comprising more than one compartment. In which case, the compartments formed from the first pouch may are in a side-by-side or ‘tire and rim’ orientation. The second film may also comprise compartments, which may or may not comprise compositions. Alternatively, the second film may be a second closed pouch used to close the multicompartment open pouch.

The unit dose article may be made by thermoforming, vacuum-forming or a combination thereof. Unit dose articles may be sealed using any sealing method known in the art. Suitable sealing methods may include heat sealing, solvent sealing, pressure sealing, ultrasonic sealing, pressure sealing, laser sealing or a combination thereof. Examples of continuous in-line processes of manufacturing water-soluble containers are set forth in U.S. Pat. No. 7,125,828, U.S. 2009/0199877A1, EP 2380965, EP 2380966, U.S. Pat. No. 7,127,874 and US2007/0241022 (all to Procter & Gamble Company, Ohio, USA). Examples of non-continuous in-line processes of manufacturing water-soluble containers are set forth in U.S. Pat. No. 7,797,912 (to Reckitt Benckiser, Berkshire, GB).

The unit dose articles may be dusted with a dusting agent. Dusting agents can include talc, silica, zeolite, carbonate or mixtures thereof.

An exemplary means of making the unit dose article of the present invention is a continuous process for making an article according to any preceding claims, comprising the steps of:

a. continuously feeding a first water-soluble film onto a horizontal portion of an continuously and rotatably moving endless surface, which comprises a plurality of moulds, or onto a non-horizontal portion thereof and continuously moving the film to said horizontal portion;

b. forming from the film on the horizontal portion of the continuously moving surface, and in the moulds on the surface, a continuously moving, horizontally positioned web of open pouches;

c. filling the continuously moving, horizontally positioned web of open pouches with a product, to obtain a horizontally positioned web of open, filled pouches;

d. preferably continuously, closing the web of open pouches, to obtain closed pouches, preferably by feeding a second water-soluble film onto the horizontally positioned web of open, filed pouches, to obtain closed pouches; and

e. optionally sealing the closed pouches to obtain a web of closed pouches.

The second water-soluble film may comprise at least one open or closed compartment.

In one embodiment, a first web of open pouches is combined with a second web of closed pouches preferably wherein the first and second webs are brought together and sealed together via a suitable means, and preferably wherein the second web is a rotating drum set-up. In such a set-up, pouches are filled at the top of the drum and preferably sealed afterwards with a layer of film, the closed pouches come down to meet the first web of pouches, preferably open pouches, formed preferably on a horizontal forming surface. It has been found especially suitable to place the rotating drum unit above the horizontal forming surface unit.

Preferably, the resultant web of closed pouches is cut to produce individual unit dose articles.

### EXAMPLES

The migration and/or presence of the bittering agent may be measured in the following way(s).

### Method for Measuring Presence/Migration of Bittering Agent

To determine the presence and/or amount of bittering agent present on the surface of the film, sensory or analytical techniques may be employed. A suitable sensory technique (e.g., via taste in controlled circumstances) is disclosed in WO2014/026855 A1, assigned to Henkel AG & Co.

The bittering agent may be extracted from the surface via the following method. The unit dose pouch is held with tweezers at the seal. The surface of the each side of the pouch is rinsed 10 times, with 4 to 5 mL of methanol used in each rinse cycle and collected. After rinsing, the methanol solution is transferred to a glass vial, and the methanol is evaporated. The remaining extract is then dissolved in the appropriate solvent needed for the analytical method.

Bittering agents can be assayed via standard methods known to those skilled in the art. Analytical techniques may include chromatography or spectroscopic techniques known to one skilled in the art. For example, suitable methods are disclosed in Falkner et al., Journal of Chromatography A. 715 (1995) 189-194, and in R. Bucci et al., Talanta 68 (2006) 781-790.

### FORMULATION EXAMPLES

All levels are in weight percent of the composition.

### Example 1

### Mono Compartment Pouches

Mono compartment pouches are filled with liquid detergents of composition A, shown in Table 1. The pouches are made using M8779 film, available from Monosol, and formed using standard thermoforming techniques. Specifically, 0.7 g of a 76 μm thick film M8779 are thermoformed to a single compartment pouch measuring 41 mm by 43 mm. The pouch is filled with 23.7 mL (25.4 g) of composition 1.1. The film comprises a bittering agent (e.g., BITREX®).

TABLE 1

| Ingredients | 1.1 |
|---|---|
| Linear C₉-C₁₅ Alkylbenzene sulfonic acid | 20 |
| C₁₂₋₁₄ alkyl 9-ethoxylate | 15 |
| Citric Acid | 1 |
| Fatty acid | 8 |
| C12-14 alkyl ethoxy 3 sulfate | 9 |
| Chelant | 1 |
| Polymer | 7 |
| Enzymes | 1 |
| Structurant | 0.15 |
| Bittering Agent (e.g., BITREX ®) | 0.02 |
| Glycerol | 6 |
| 1,2 propanediol | 11 |
| Water | 10 |
| Mono-ethanolamine or NaOH (or mixture | neutralize to pH |
| thereof) | to about 7.4 |
| Additives, Minor | To 100% |

### Example 2

### Multi Compartment Pouches

Examples of multicomponent pouches can include the formulations presented in Table 2. The pouches are made with water-soluble film according to those disclosed in US Patent Application 2011/0188784A1. The film comprises a bittering agent (e.g., BITREX®) in an amount of 500 ppm (based on parts of film).

TABLE 2

| | 2.1 | | | 2.2 | | 2.3 | | |
|---|---|---|---|---|---|---|---|---|
| | 3 compartments | | | 2 compartments | | 3 compartments | | |
| Compartment # | 1 | 2 | 3 | 1 | 2 | 1 | 2 | 3 |
| Dosage (g) | 34.0 | 3.5 | 3.5 | 30.0 | 5.0 | 25.0 | 1.5 | 4.0 |
| Ingredients | Weight % | | | | | | | |
| Alkylbenzene sulfonic acid | 20.0 | 20.0 | 20.0 | 10.0 | 20.0 | 20.0 | | |
| Alkyl sulfate | | | | 2.0 | | | | |
| C12-14 alkyl 7-ethoxylate | 17.0 | 17.0 | 17.0 | | 17.0 | 17.0 | | |
| Cationic surfactant | | | | 1.0 | | | | |
| Zeolite A | | | | 10.0 | | | | |
| C12-18 Fatty acid | 13.0 | 13.0 | 13.0 | | 18.0 | 18.0 | | |
| Sodium acetate | | | | 4.0 | | | | |
| Enzymes | 0-3 | 0-3 | 0-3 | 0-3 | | 0-3 | | |
| Sodium Percarbonate | | | | 11.0 | | | | |
| TAED | | | | 4.0 | | | | |
| Organic catalyst ¹ | | | | 1.0 | | | | |
| PAP granule ² | | | | | | | | 50 |
| Polycarboxylate | | | | 1.0 | | | | |
| Ethoxysulfated | 2.2 | 2.2 | 2.2 | | | | | |
| Hexamethylene Diamine | | | | | | | | |
| Dimethyl Quat | | | | | | | | |
| Hydroxyethane | 0.6 | 0.6 | 0.6 | 0.5 | | | | |
| diphosphonic acid | | | | | | | | |
| Ethylene diamine | | | | | | 0.4 | | |
| tetra(methylene phosphonic) | | | | | | | | |
| acid | | | | | | | | |
| Brightener | 0.2 | 0.2 | 0.2 | 0.3 | | 0.3 | | |
| Alkoxylated polyamine ⁶ | 5 | | | | 4 | 7 | | |
| Hueing dye ⁴ | | | 0.05 | | 0.035 | | 0.12 | |
| Perfume | 1.7 | 1.7 | | 0.6 | | 1.5 | | |
| Bittering Agent (e.g., | 0.1 | | | | 0.3 | 0.25 | | |
| BITREX ^{®}) | | | | | | | | |
| Water | 10.0 | 10.0 | 10.0 | | 4.0 | | | |
| Glycerol | 5 | | | | | 6 | 15 | |
| Sorbitol | | | | | 1 | | | |
| Propane diol | 5 | 5 | 5 | | 30 | 11 | 84 | |

| | |
|---|---|
| Buffers (sodium | To pH 8.0 for liquids |
| carbonate, | To RA > 5.0 for powders |
| monoethanolamine) ⁵ | |
| Minors (antioxidant, | To 100% |
| aesthetics, . . . ), sodium | |
| sulfate for powders | |

¹ Sulfuric acid mono-[2-(3,4-dihydro-isoquinolin-2-yl)-1-(2-ethyl-hexyloxymethyl)-ethyl]ester as described in U.S. Pat. No. 7,169,744.
² PAP = Phtaloyl-Amino-Peroxycaproic acid, as a 70% active wet cake
³ Polyethylenimine (MW = 600) with 20 ethoxylate groups per —NH.
⁴ Ethoxylated thiophene, EO (R₁ + R₂) = 5
⁵ RA = Reserve Alkalinity (g NaOH/dose)
⁶ PEI600 EO20, available from BASF

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A unit dose article comprising:
a. water-soluble film, wherein said film comprises a first bittering agent; and
b. a liquid composition encapsulated by said film, wherein said liquid composition comprises a second bittering agent.

2. The unit dose article according to claim 1, wherein said first bittering agent and said second bittering agent are the same bittering agent.

3. The unit dose article according to claim 1, wherein said first bittering agent, said second bittering agent, or both comprises a member selected from the group consisting of denatonium salts or a derivative thereof; Quercetin (3,3′,4′,5,7-pentahydroxyflavone); Naringin (4′,5,7-Trihydroxyflavanone-7-rhamnoglucoside); Aucubin; Amarogentin; Dihydrofoliamentin; Gentiopicroside; Gentiopicrin; Swertiamarin; Swerosid; Gentioflavosid; Centaurosid; Methiafolin; Harpagoside; Centapikrin; Sailicin; Kondurangin; Absinthin; Artabsin; Cnicin; Lactucin; Lactucopicrin; Salonitenolid; α-thujone; β-thujone; Desoxy Limonene; Limonin; Ichangin; iso-Obacunoic Acid; Obacunone; Obacunoic Acid; Nomilin; Ichangin; Nomilinoic acid; Marrubin; Prämarrubin; Carnosol; Carnosic acid; Quassin; Quinine hydrochloride; Quinine sulfate; Quinine dihydrochloride; Columbine; Caffeine; Threonine; Methionine; Phenylalanine; Tryptophan; Arginine; Histidine; Valine; Aspartic acid; Sucrose octaacetate; Qunine bisulfate; hop extract; and mixtures thereof.

4. The unit dose article according to claim 3, wherein said first and/or second bittering agent is a denatonium salt or derivative thereof.

5. A unit dose article according to claim 1, wherein both said film and said liquid composition comprise said bittering agents at the time of manufacture of said unit dose article.

6. A unit dose article according to claim 1, wherein said film is made by an extrusion process or a casting process.

7. A unit dose article according to claim 1, wherein said film comprises a water-soluble polymer, wherein said polymer comprises a polyvinyl alcohol that is from about 80% to about 99% hydrolysed.

8. A unit dose article according to claim 1, wherein said film further comprises a plasticizing agent selected from the group consisting of water, glycerol, diethylene glycol, sorbitol, and mixtures thereof.

9. A unit dose article according to claim 8, wherein said film comprises from about 2% to about 35%, by weight of said film, of plasticizing agent.

10. A unit dose article according to claim 1, wherein said liquid composition further comprises from about 10% to about 50%, by weight of said liquid composition, of plasticizing solvent.

11. A unit dose article according to claim 1,
wherein said water-soluble film comprises polyvinyl alcohol having a degree of hydrolysis of from about 80% to about 99%;
wherein said film further comprises from about 2% to about 35%, by weight of said film, of a plasticizing agent, wherein said plasticizing agent is selected from the group consisting of water, glycerol, diethylene glycol, sorbitol, and mixtures thereof; and
wherein said liquid composition further comprises from about 10% to about 50%, by weight of said liquid composition, of plasticizing solvent.

12. A unit dose article according to claim 1, wherein said first bittering agent can be found on the surface of the film in an amount in an amount sufficient to provide a bitter taste.

13. A method of making a unit dose article, comprising the steps of:
a. providing a water-soluble film, wherein said film comprises a first bittering agent;
b. providing a liquid composition, wherein said liquid composition comprises a second bittering agent;
c. encapsulating said liquid composition in said water-soluble film.

14. A method according to claim 13, wherein said first bittering agent, said second bittering agent, or both comprises a member selected from the group consisting of: denatonium salts or a derivative thereof; Quercetin (3,3′,4′,5,7-pentahydroxyflavone); Naringin (4′,5,7-Trihydroxyflavanone-7-rhamnoglucoside); Aucubin; Amarogentin; Dihydrofoliamentin; Gentiopicroside; Gentiopicrin; Swertiamarin; Swerosid; Gentioflavosid; Centaurosid; Methiafolin; Harpagoside; Centapikrin; Sailicin; Kondurangin; Absinthin; Artabsin; Cnicin; Lactucin; Lactucopicrin; Salonitenolid; α-thujone; β-thujone; Desoxy Limonene; Limonin; Ichangin; iso-Obacunoic Acid; Obacunone; Obacunoic Acid; Nomilin; Ichangin; Nomilinoic acid; Marrubin; Prämarrubin; Carnosol; Carnosic acid; Quassin; Quinine hydrochloride; Quinine sulfate; Quinine dihydrochloride; Columbine; Caffeine; Threonine; Methionine; Phenylalanine; Tryptophan; Arginine; Histidine; Valine; Aspartic acid; Sucrose octaacetate; Qunine bisulfate; hop extract; and mixtures thereof.

15. A method according to claim 14, wherein said first bittering agent, said second bittering agent, or both is denatonium benzoate.

16. A method according to claim 13, wherein said first bittering agent and said second bittering agent are the same bittering agent.

17. A method according to claim 13, wherein said liquid comprises from about 50 to about 2500 ppm of said second bittering agent.

18. A method according to claim 13, wherein said film comprises from about 50 to about 1000 ppm of said first bittering agent.

19. A method according to claim 18, wherein the ratio of ppm of said second bittering agent to the ppm of said first bittering agent is from about 5:1 to about 1:2.

20. A method according to claim 13, wherein said liquid composition further comprises a plasticizing solvent comprising water, glycerol, diethylene glycol, dipropylene glycol, sorbitol, or mixtures thereof.

21. A method according to claim 13, wherein said liquid composition comprises from about 2% to about 20%, by weight of said liquid composition, of water.

22. A method according to claim 13, wherein said film further comprises from about 2% to about 35%, by weight of said film, of a plasticizing agent selected from the group consisting of water, glycerol, diethylene glycol, sorbitol, and mixtures thereof.

23. A method according to claim 13, wherein said unit dose article comprises two or more compartments.
